(19) United States
(12) Patent Application Publication
(10) Pub. No.: US 2025/0291675 A1
(43) Pub. Date: Sep. 18, 2025

(54) MEMORY DEVICES, MEMORY SYSTEMS AND OPERATION METHODS THEREOF

(71) Applicant: Yangtze Memory Technologies Co., Ltd., Wuhan (CN)

(72) Inventors: Zhe Zhang, Wuhan (CN); Xue Wu, Wuhan (CN); Zhen Huang, Wuhan (CN); Wei Wu, Wuhan (CN); Shilin Yuan, Wuhan (CN); Kang Li, Wuhan (CN)

(21) Appl. No.: 18/544,081

(22) Filed: Mar. 15, 2024

(51) Int. Cl. G06F 11/10

(52) U.S. Cl. CPC G06F 11/108; G06F 11/1004; G06F 11/1016

(57) ABSTRACT

Examples of the present disclosure provide a memory device, a memory system and an operation method thereof. The memory device includes: at least one memory die, and a first memory region comprising a plurality of pages and configured to: store first check data, wherein the first check data comprises a plurality of groups of check data; each of the plurality of groups of check data corresponds to a plurality of page rows in each of designated word lines, the designated word lines comprising multiple word lines without an interval or with a fixed interval; and each group of check data is obtained from data stored in corresponding page rows and a plurality of different coding equations.

### TECHNICAL FIELD

Examples of the present disclosure relate to the technical field of semiconductors, and particularly to memory devices, memory systems and operation methods thereof.

### BACKGROUND

A Redundant Array of Independent Disks (RAID) is a disk array combining a plurality of independent disks together by different combination manners. The RAID can provide good fault tolerance performance through a data check/mirroring function, thereby enhancing the safety of data storage. The RAID has been widely applied in various fields of data storage and data protection, for example, a RAID technology is utilized to recover data lost by a memory.

### BRIEF DESCRIPTION OF THE DRAWINGS

FIG. 1 is a schematic diagram of an example system having a memory device provided by examples of the present disclosure;

FIG. 2A is a schematic diagram of a memory card provided by examples of the present disclosure;

FIG. 2B is a schematic diagram of an SSD provided by examples of the present disclosure;

FIG. 3 is a schematic diagram of a memory device provided by examples of the present disclosure;

FIG. 4 is a schematic diagram of another memory device provided by examples of the present disclosure;

FIG. 5 is a schematic diagram that a data error occurs in another memory device provided by examples of the present disclosure;

FIG. 6 is a schematic diagram of generating first check data through an equation coefficient matrix provided by examples of the present disclosure;

FIGS. 7A to 7F are schematic diagrams of a process of performing data recovery using check data generated by Galois elements with different intervals provided by examples of the present disclosure;

FIG. 8 is a schematic diagram of a memory system provided by examples of the present disclosure; and

FIG. 9 is an operation flow diagram of performing error correction in a read operation provided by examples of the present disclosure.

### DETAILED DESCRIPTION

For ease of understanding of the present disclosure, example implementations of the present disclosure will be described below in more detail with reference to the relevant drawings. Although the example implementations of the present disclosure are shown in the drawings, it is to be understood that the present disclosure may be achieved in various forms which should not be limited by the specific implementations as set forth herein. Rather, these implementations are provided for a more thorough understanding of the present disclosure, and can fully convey the scope of the present disclosure to those skilled in the art.

In the following description, numerous specific details are presented to provide a more thorough understanding of the present disclosure. However, it is apparent to those skilled in the art that the present disclosure may be implemented without one or more of these details. In some examples, in order to avoid confusing with the present disclosure, some technical features well-known in the art are not described; that is, not all features of actual examples are described herein, and well-known functions and structures are not described in detail.

In general, terminologies may be understood at least in part from usage in the context. For example, the term “one or more” as used herein, depending at least in part upon the context, can be used to describe any feature, structure, or characteristic in a singular sense or can be used to describe combinations of features, structures, or characteristics in a plural sense. Similarly, terms, such as “a/an” or “the” again, can be understood to convey a singular usage or to convey a plural usage, depending at least in part upon the context. In addition, the term “based on” may be understood as not necessarily intended to convey an exclusive set of factors and may, instead, allow for existence of additional factors not necessarily expressly described, again, depending at least in part upon the context.

The terms as used herein are only intended to describe the specific examples, and are not used as limitations of the present disclosure, unless otherwise defined. As used herein, unless otherwise indicated expressly in the context, “a”, “one” and “the” in a singular form are also intended to include a plural form. It should also be understood that the terms “consist of” and/or “comprise”, when used in this specification, determine the presence of a feature, integer, step, operation, element and/or component, but do not preclude the presence or addition of one or more of other features, integers, steps, operations, elements, components, and/or groups. As used herein, the term “and/or” includes any and all combinations of the listed relevant items.

In order to understand the present disclosure thoroughly, detailed operations and detailed structures will be proposed in the following description to set forth the technical solution of the present disclosure. The detailed descriptions of the preferred examples of the present disclosure are as follows. However, the present disclosure may also have other implementations in addition to these detailed descriptions.

Therefore, how to further improve an error correction capability of the RAID in the memory becomes an urgent issue to be addressed in the industry.

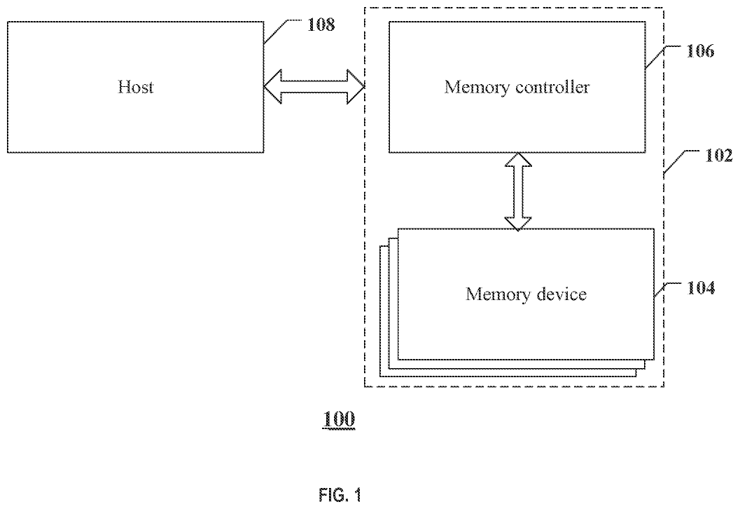

FIG. 1 illustrates a block diagram of an example system 100 having a memory device, according to some aspects of the present disclosure. The system 100 may be a mobile phone, a desktop computer, a laptop computer, a tablet computer, a vehicle computer, a gaming console, a printer, a positioning apparatus, a wearable electronic apparatus, a smart sensor, a virtual reality (VR) apparatus, an augmented reality (AR) apparatus, or any other suitable electronic apparatuses having storage therein. As shown in FIG. 1, the system 100 may comprise a host 108 and a memory system 102, wherein the memory system 102 has one or more memory devices 104 and a memory controller 106. The host 108 may be a processor (e.g., a central processing unit (CPU)) or a system on chip (SOC) (e.g., an application processor (AP)) of an electronic apparatus. The host 108 may be configured to send or receive data to or from the memory devices 104.

According to some implementations, the memory controller 106 is coupled to the memory devices 104 and the host 108 and is configured to control the memory devices 104. The memory controller 106 can manage the data stored in the memory devices 104 and communicate with the host 108. In some implementations, the memory controller 106 is designed for operating in a low duty-cycle environment such as Secure Digital (SD) cards, Compact Flash (CF) cards, Universal Serial Bus (USB) flash drives, or other media for use in electronic apparatuses, such as personal computers, digital cameras, and mobile phones, etc. In some implementations, the memory controller 106 is designed for operating in high duty-cycle environment Solid-State Drives or embedded Multi-Media Cards (eMMCs) used as data storage for mobile devices, such as smartphones, tablets, and laptop computers, etc., and enterprise memory arrays.

The memory controller 106 may be configured to control operations of the memory devices 104, such as read, erase, and program operations. The memory controller 106 may be further configured to manage various functions with respect to data stored or to be stored in the memory devices 104, including, but not limited to, bad-block management, garbage collection, logical-to-physical address conversion, and wear leveling, etc. In some implementations, the memory controller 106 is further configured to process error correction codes (ECCs) with respect to the data read from or written to the memory devices 104. The memory controller 106 may further perform any other suitable functions as well, for example, formatting the memory devices 104. The memory controller 106 may communicate with a host (e.g., the host 108) according to a particular communication protocol. For example, the memory controller 106 may communicate with the host through at least one of various interface protocols, such as a USB protocol, a MMC protocol, a Peripheral Component Interconnection (PCI) protocol, a PCI-Express (PCI-E) protocol, an Advanced Technology Attachment (ATA) protocol, a Serial-ATA protocol, a Parallel-ATA protocol, a Small Computer Small Interface (SCSI) protocol, an Enhanced Small Disk Interface (ESDI) protocol, an Integrated Drive Electronics (IDE) protocol, and a Firewire protocol, etc.

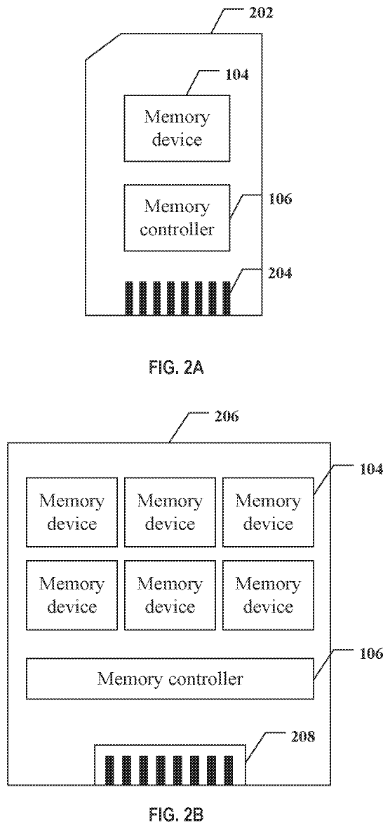

The memory controller 106 and the one or more memory devices 104 can be integrated into various types of storage apparatuses, for example, be included in the same package, such as a Universal Flash Storage package or an eMMC package. That is to say, the memory system 102 can be implemented and packaged into different types of end electronic products. In one example as shown in FIG. 2A, the memory controller 106 and a single memory device 104 may be integrated into a memory card 202. The memory card 202 may include a PC card (PCMCIA, Personal Computer Memory Card International Association), a CF card, a Smart Media (SM) card, a memory stick, a Multimedia card (MMC, RS-MMC, MMCmicro), an SD card (SD, miniSD, microSD, SDHC), and a UFS, etc. The memory card 202 may further comprise a memory card connector 204 coupling the memory card 202 with a host (e.g., the host 108 in FIG. 1). In another example as shown in FIG. 2B, the memory controller 106, and multiple memory devices 104 may be integrated into an SSD 206. The SSD 206 may further include an SSD connector 208 coupling the SSD 206 with a host (e.g., the host 108 in FIG. 1). In some implementations, the storage capacity and/or the operation speed of the SSD 206 are greater than the storage capacity and/or the operation speed of the memory card 202.

In the examples of the present disclosure, each of memory dies may comprise one or more memory cell arrays. One type of memory cell, e.g., a single-level cell (SLC), may store one bit per cell. Other types of memory cells, e.g., a multiple-level cell (MLC), a triple-level cell (TLC), a quad-level cell (QLC) and a quintuple-level cell (PLC) may store multiple bits per cell. In some examples, each of the memory devices may comprise one or more memory cell arrays, such as an SLC, an MLC, a TLC, a QLC, or any combination of such memory cell arrays.

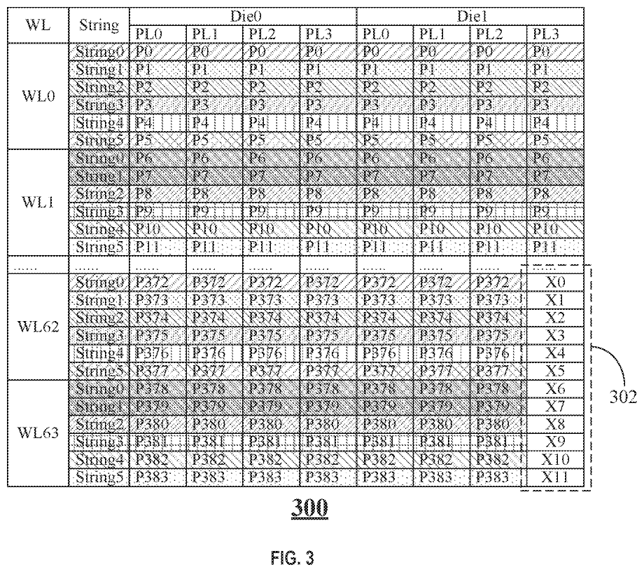

In some examples, FIG. 3 shows a partial schematic diagram of a memory device 300. Here, the memory device 300 may be a non-volatile memory device, such as a NAND memory, a NOR memory, or the like. The memory device 300 comprises at least one memory die, wherein each memory die comprises at least one memory plane; each memory plane corresponds to the same plurality of word lines (WLs); each word line is coupled with a plurality of memory strings; one memory string coupled with one word line corresponding to one memory plane forms one page; one minimum cell in FIG. 3 represents one page; and one memory string coupled with one word line corresponding to all memory planes forms a page row. In an example, in a 3D NAND memory, each memory plane may comprise a plurality of memory blocks, wherein a memory block is the minimum unit for performing an erase operation, while gate line slits may divide one memory block into a plurality of memory fingers. A top select gate cut (TSG cut) may be disposed, for example, in the middle of each memory finger to divide a top select gate (TSG) of the memory finger into two portions, such that the memory finger may be divided into two memory strings, wherein memory cells in a memory string that share the same word line form a programmable (read/write) page.

As a semiconductor manufacturing process is more and more advanced, a number of stack layers of the memory device is increasingly higher, and its storage capacity is increasingly larger. In order to protect safety of data more effectively, improve reliability of a product and reduce failure of the memory due to its own defects, a RAID technology is generally utilized to group the data written to the memory device, and then perform operations for a plurality of groups of write data through a same coding equation (for example, performing an XOR operation for each group of write data) to obtain a plurality of groups of corresponding check data (Parity), wherein the plurality of groups of write data correspond to the plurality of groups of check data one to one. When a data error or failure occurs, each group of check data may correct and recover one piece of error data in one corresponding group of data, that is, the essence of the method is to solve a linear equation with one unknown through the check data. If it is desired to obtain a higher error correction capability, a plurality of different coding equations need to be constructed, so as to generate a plurality of groups of check data for a group of write data. By solving an equation set, multiple pieces of error data in a group of write data can be corrected and recovered. In some examples, at least one of RAID5 or RAID6 may be achieved through a memory controller for error correction of the data in the memory device 300.

For ease of understanding, in an example, FIG. 3 shows 2 memory dies Die0 and Die1 in the memory device 300. Each memory die comprises 4 memory planes PL0, PL1, PL2 and PL3, each memory plane corresponds to 64 word lines WL0, WL1, . . . , WL63, and each word line is coupled with 6 memory strings String0, String1, . . ., String5. It is to be noted that the numbers of memory dies, memory planes, word lines and memory strings are only examples here. The present disclosure does not impose excessive limitations thereto. Specific numbers of memory dies, memory planes, word lines and memory strings may be determined according to performance demands and design demands of an actual product. Here, one memory string (such as String0) coupled with one word line (such as WL0) corresponding to all memory planes (such as 8 memory planes in Die0 and Die1) may form one page row (such as 8 pages P0 on the same row). Data written to all the pages in the 2 memory dies as mentioned above may be grouped through the RAID technology, for example, the data in 32 page rows (such as page rows corresponding to P0, P12, P24, . . . , P372) formed by the memory strings with the same number coupled with 32 designated word lines WL0, WL2, WL4, . . . , WL62 may act as a group of write data; and the data in 32 page rows (such as page rows corresponding to P6, P18, P30, . . . , P378) formed by the memory strings with the same number coupled with 32 designated word lines WL1, WL3, WL5, . . . , WL63 may act as a group of write data. That is to say, the designated word lines here comprises a plurality of word lines with a fixed interval that is 1. It is to be noted that the fixed interval may also be any other number, to which the present disclosure does not impose excessive limitations. Furthermore, the designated word lines may also comprise a plurality of word lines with no intervals, and the specific illustration may be referred to the following.

In an example, the data written to all the pages in FIG. 3 are divided into 12 groups. The data written to the page row corresponding to the memory string String0 coupled with the designated word lines WL0, WL2, WL4, . . . , WL62 is a first group; the data written to the page row corresponding to the memory string String1 coupled with the designated word lines WL0, WL2, WL4, . . . , WL62 is a second group; . . . ; the data written to the page row corresponding to the memory string String5 coupled with the designated word lines WL0, WL2, WL4, . . . , WL62 is a sixth group; the data written to the page row corresponding to the memory string String0 coupled with the designated word lines WL1, WL3, WL5, . . . , WL63 is a seventh group; the data written to the page row corresponding to the memory string String1 coupled with the designated word lines WL1,WL3, WL5, . . . , WL63 is an eighth group; . . . ; and the data written to the page row corresponding to the memory string String5 coupled with the designated word lines WL1, WL3, WL5, . . . , WL63 is a twelfth group.

As such, an operation is performed respectively for the above 12 groups of data with the same coding equation (for example, an XOR operation is performed for each group of data), thereby obtaining 12 corresponding groups of check data X0, X1, . . . , X11. Each group of check data may correspond to one page row in each of designated word lines, and each group of check data can correct and recover one piece of error data in a corresponding group of write data. In some examples, a size of each group of check data shown in FIG. 3 may be 16 KB, and a total capacity of 12 groups of check data is 192 KB. On this basis, if it is desired to further improve an error correction capability of the memory, there is a need to consider regrouping the write data and building more coding equations.

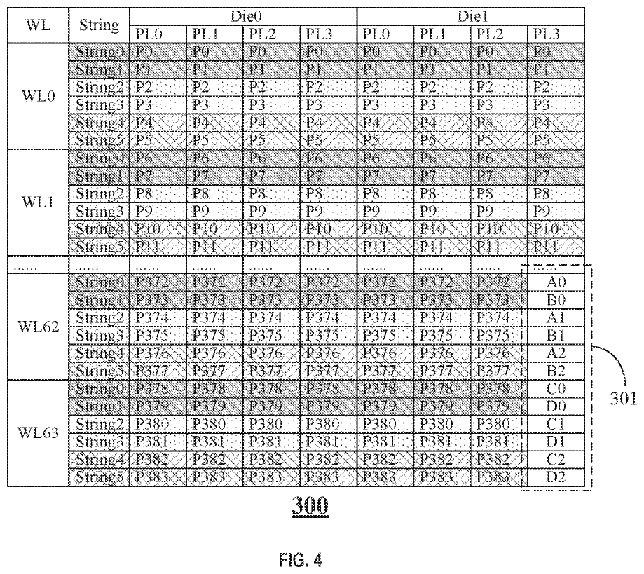

As shown in FIG. 4, the present disclosure provides a memory device 300 which comprises: at least one memory die (Die0, Die1), wherein each memory die comprises at least one memory plane (e.g., PL0 to PL3), each memory plane corresponds to the same plurality of word lines (e.g., WL0 to WL63), each word line is coupled with a plurality of memory strings (e.g., String0 to String5), one memory string coupled with one word line corresponding to one memory plane forms one page, and one memory string coupled with one word line corresponding to all memory planes forms one page row; and a first memory region 301 comprising a plurality of pages and configured to store first check data (A0 to A3, B0 to B3, C0 to C3, D0 to D3), wherein the first check data comprises a plurality of groups of check data, each group of check data of the plurality of groups of check data corresponds to a plurality of page rows in each of designated word lines that includes multiple word lines without an interval or with a fixed interval, and each group of check data is obtained from data stored in the corresponding page rows and a plurality of different coding equations.

In the examples of the present disclosure, referring to FIG. 4, the first memory region 301 in the memory device 300 is used to store the first check data. In an example, the first check data may include 3 groups of check data, each of which comprises 4 check data (here, one check data occupies one page, such as A0), wherein A0, B0, C0 and D0 are the first group of check data, A1, B1, C1 and D1 are the second group of check data, and A2, B2, C2 and D2 are the third group of check data. Accordingly, the data written to all the pages in FIG. 4 are divided into 3 groups, wherein the data written to the page row corresponding to the memory strings String0 and String1 coupled with the designated word lines WL0, WL1, WL2, . . . , WL63 is the first group of data; the data written to the page row corresponding to the memory strings String2 and String3 coupled with the designated word lines WL0, WL1, WL2, . . . , WL63 is the second group of data; and the data written to the page row corresponding to the memory strings String4 and String5 coupled with the designated word lines WL0, WL1, WL2, . . . , WL63 is the third group of data. That is to say, the designated word lines here comprise a plurality of word lines without an interval (refer to the above example corresponding to FIG. 3 for the case with the fixed interval). Operations are performed for the above first group of write data with 4 different coding equations, which can obtain the first group of check data A0, B0, C0, D0. Operations are performed for the above second group of write data with 4 different coding equations, which can obtain the second group of check data A1, B1, C1, D1. Operations are performed for the above third group of write data with 4 different coding equations, which can obtain the third group of check data A2, B2, C2, D2. As such, each group of check data can correct and recover 4 pieces of error data in a corresponding group of write data, thereby improving the error correction capability and the data reliability of a memory. In some examples, compared with the RAID solution shown in FIG. 3, a size of the first check data generated by the RAID solution shown in FIG. 4 is not increased, and may be still 192 KB.

It is to be noted that the solution shown in FIG. 4 is only an example, and the grouping manner and a number of groups of the write data in the above memory device, and a number of coding equations may be changed according to actual demands, which is not limited herein. For example, if a storage capacity occupied by the first check data needs to be reduced, the number of the coding equations may be reduced, or the number of the groups of the write data may be reduced. Similarly, if the error correction capability needs to be further enhanced, the number of the coding equations may be increased, or the number of the groups of the write data may be increased.

It may be understood that in the examples of the present disclosure, each group of check data corresponds to the plurality of page rows in the designated word line, and each group of check data is obtained from the data stored in the corresponding page rows and the plurality of different coding equations. As such, on the one hand, a corresponding group of check data may be generated from the data stored in the plurality of page rows in the designated word lines through the plurality of different coding equations, such that the storage capacity occupied by the first check data is smaller; on the other hand, a group of check data may correct a plurality of errors of the same number as the number of the plurality of coding equations, thus improving the error correction capability of the memory and further improving the data reliability of the memory.

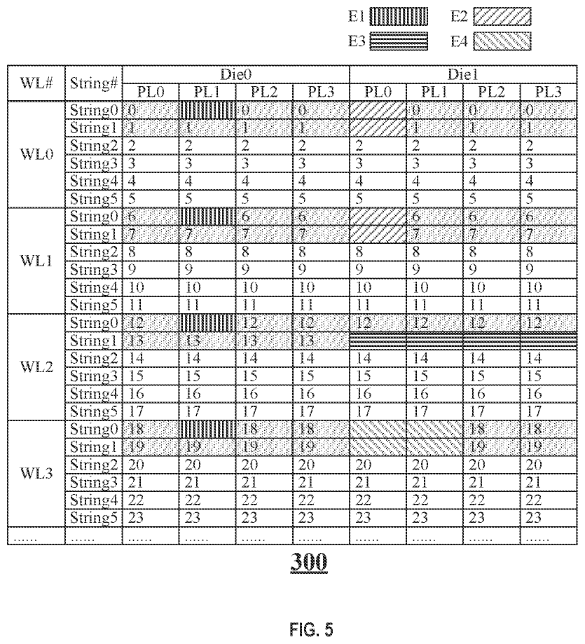

In some examples, as shown in FIG. 5, the memory device 300 provided by the present disclosure may correct and recover a plurality of pieces of error data in each group of data, and the plurality of pieces of error data in each group of data here may include multiple distributions. In an example, referring to first type of error data E1 shown in FIG. 5, 4 pieces of error data E1 of the first type may be distributed in the memory string (such as String0) with the same number coupled with the different designated word lines (such as WL0, WL1, WL2, WL3); referring to a second type of error data E2 shown in FIG. 5, 4 pieces of error data E2 of the second type may be distributed in the plurality of memory strings (such as String0 and String1) coupled with the different designated word lines (such as WL0, WL1); referring to a third type of error data E3 shown in FIG. 5, 4 pieces of error data E3 of the third type may be distributed in the same memory string (String1) coupled with the same designated word lines (WL2) but in different memory planes (PL0 to PL3) in the same memory die (Die1); and referring to a fourth type of error data E4 shown in FIG. 5, 4 pieces of error data E4 of the fourth type may be distributed in the same designated word lines (WL3). It is to be noted that, in addition to the 4 types of error data distributions shown in FIG. 5, the memory device 300 provided by the present disclosure may also achieve correction and recovery of the error data of other distributions, as long as a number of pieces of error data appearing in the same group of write data does not exceed a number of the coding equations, which is not limited herein.

In some examples, as shown in FIG. 4, the first memory region 301 comprises P pages, and the first check data comprises Q groups of check data, and each group of check data is obtained from the data stored in the corresponding page rows and P/Q different coding equations, wherein both P and Q are integers greater than 1, and P is a multiple of Q.

In an example, referring to FIG. 4, the first check data may comprise 3 groups of check data, each of which is obtained from the data stored in the corresponding page rows and 4 different coding equations, and the data stored in the corresponding page rows here refers to one of the above write data groups. As such, one check data generated by one write data group and one coding equation occupies one page (such as A0), one group of check data includes 4 check data, i.e., occupying 4 pages, and thus, the first memory region 301 may comprise 12 pages. That is to say, the number of the groups of the check data is equal to the number of the groups of the write data in the memory. Therefore, here, Q may also represent the number of the groups of the write data, P/Q is the number of the coding equations, and P is the number of pages occupied by the first check data.

In some examples, the number P of the pages included in the first memory region 301 may be jointly determined by the number of the coding equations and the number of the groups of the write data. In some other examples, the number of the pages included in the first memory region 301 may be also greater than or equal to a product of the number of the coding equations and the number of the write data groups.

In some examples, as shown in FIG. 4, the first memory region 301 comprises twelve pages, the first check data comprises three groups of check data, each word line is coupled with six memory strings, and the three groups of check data correspond to two adjacent page rows in each word line respectively.

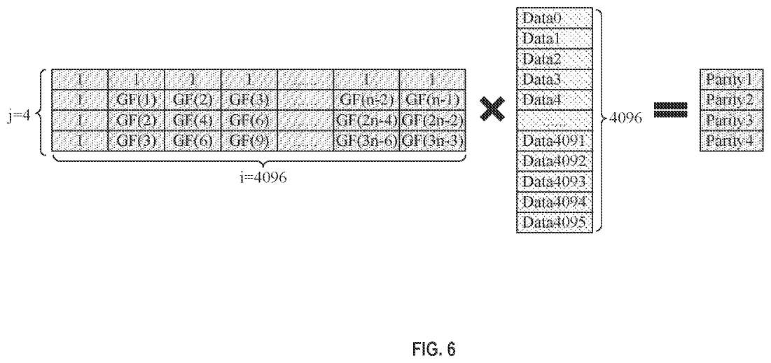

In some examples, as shown in FIG. 6, each group of check data is obtained by multiplying an equation coefficient matrix corresponding to each of the plurality of different coding equations by a column vector formed by the data stored in all the pages included in the plurality of page rows in the designated word lines corresponding to each group of check data; and a number of columns included in the equation coefficient matrix corresponding to each coding equation is the same as a number of rows included in the column vector.

In the examples of the present disclosure, an illustration is made by taking the memory device comprising SLC type memory cells, the memory device comprising 4 memory dies, each memory die comprising 4 memory planes, each memory plane corresponding to the same 128 word lines (e.g., a 128-layer NAND memory) and each word line being coupled with 6 memory strings as an example. A write data grouping solution of the RAID may be referred to the example shown in FIG. 4, that is, the data written to the memory strings String0and String1 coupled with the designated word lines WL0, WL1, WL2, . . . , WL127 without an interval is a first group of data, the data written to the memory strings String2 and String3 coupled with the designated word lines WL0, WL1, WL2, . . . , WL127 is a second group of data, and the data written to the memory strings String4 and String5 coupled with the designated word lines WL0, WL1, WL2, . . . , WL127 is a third group of data (WL64 to WL127 not shown in FIG. 4). That is to say, the data written to 2 adjacent memory strings in all the word lines is a group, and a group of write data comprises the data written to 128 (WL)×2 (String)×4 (Die)×4 (Plane)=4096 pages. A group of write data forms a column vector. A number of rows of the column vector is 4096. Each row of the column vector comprises the data written to one page. As such, a number i of columns included in the corresponding coefficient matrix is equal to 4096. The number of the coding equations is 4, so a number j of rows included in the coefficient matrix corresponding to the 4 coding equations is equal to 4. Each row of the coefficient matrix represents one coding equation, that is, each row of the coefficient matrix is an equation coefficient matrix. Each coding equation at least comprises 2¹²=4096 coefficients. A check data column vector of j rows may be obtained by multiplying a coefficient matrix of i rows and j columns by a column vector of i rows formed by a group of write data. Here, the check data column vector is a group of check data, and the check data column vector has j rows, meaning that a group of check data comprises j check data (such as Parity1 to Parity4 in FIG. 6), and occupies j pages.

It is to be noted that the coefficient matrix in the present disclosure refers to a matrix with a plurality of rows formed by coefficients of a plurality of coding equations, and the equation coefficient matrix refers to one of rows in the coefficient matrix, that is, each equation coefficient matrix corresponds to one coding equation.

In some examples, the memory device comprises TLC type memory cells. In this case, the write data may be divided into 9 groups through the RAID.

In some examples, the equation coefficient matrices corresponding to respective ones of the plurality of different coding equations are linearly independent from each other.

In the examples of the present disclosure, in order to enable a group of check data generated by j coding equations to correct j pieces of error data in a corresponding group of write data, the equation coefficient matrices corresponding to respective ones of j different coding equations need to be linearly independent from each other, such that the j pieces of error data in the corresponding group of write data can be recovered using equations set solution.

In some examples, as shown in FIG. 6, the plurality of different coding equations include a first coding equation and at least one remaining coding equation, wherein an equation coefficient matrix corresponding to the first coding equation comprises N “1” elements, and an equation coefficient matrix corresponding to each of the at least one remaining coding equation comprises “1” and N-1 consecutive non-zero elements. The N-1 consecutive non-zero elements in the equation coefficient matrix corresponding to a different coding equation include Galois elements with a different interval, wherein N is an integer greater than 1, and N is a total number of the pages corresponding to each group of check data.

In the examples of the present disclosure, referring to FIG. 6, coefficients of the first coding equation correspond to a first row of the coefficient matrix, that is, the coefficients of the first coding equation are N “1” elements. Here, N may be equal to the total number of the pages corresponding to each group of check data, that is, a number (i in the above examples) of pages occupied by a group of write data.

Three remaining coding equations correspond to a second row, a third row and a fourth row of the coefficient matrix (this is only an example, and the number of the remaining coding equations is not limited), that is to say, i elements in each of the second row, the third row and the fourth row are i coefficients of the corresponding remaining coding equation respectively. A first coefficient of each remaining coding equation is 1, and a second coefficient to an Nth coefficient are Galois elements with different intervals. In an example, in the second row, the second element to the Nth element are N-1 Galois elements GF(1), GF(2), . . . , GF(n-1) with an interval of 1 respectively; in the third row, the second element to the Nth element are N-1 Galois elements GF(2), GF(4), . . . , GF(2n-2) with an interval of 2 respectively; and in the fourth row, the second element to the Nth element are N-1 Galois elements GF(3), GF(6), . . . , GF(3n-3) with an interval of 3 respectively.

As such, referring to the first row of the coefficient matrix in FIG. 6, N “1” elements may be selected as coefficients to generate Pairty1 (similar to an XOR operation in the RAID5); referring to the second row of the coefficient matrix in FIG. 6, the “1” element and the N-1 consecutive non-zero elements are selected as coefficients to generate Parity2, wherein a multiplying operation is a finite field GF operation; referring to the third row of the coefficient matrix in FIG. 6, the “1” element and the N-1 consecutive elements with an index of a multiple of 2 are selected as coefficients to generate Pairty3, wherein a multiplying operation is a finite field GF operation; and referring to the fourth row of the coefficient matrix in FIG. 6, the “1” element and the N-1 consecutive elements with an index of a multiple of 3 are selected as coefficients to generate Pairty4, wherein a multiplying operation is a finite field GF operation. It is to be noted that different Galois field elements are taken as coefficients for coding, which is equivalent to a randomization process of the data written to different pages, wherein each group of write data is coded using a same seed, and the XOR operation is performed for the data in all the pages corresponding to the same group of write data. Here, for ease of understanding, different coding equation coefficients are recorded using a matrix.

In some examples, a Galois field requires GF(2\hat{ }12). In order to reach better ductility and demands of the coefficients, 16-bit GF(2\hat{ }16) is taken.

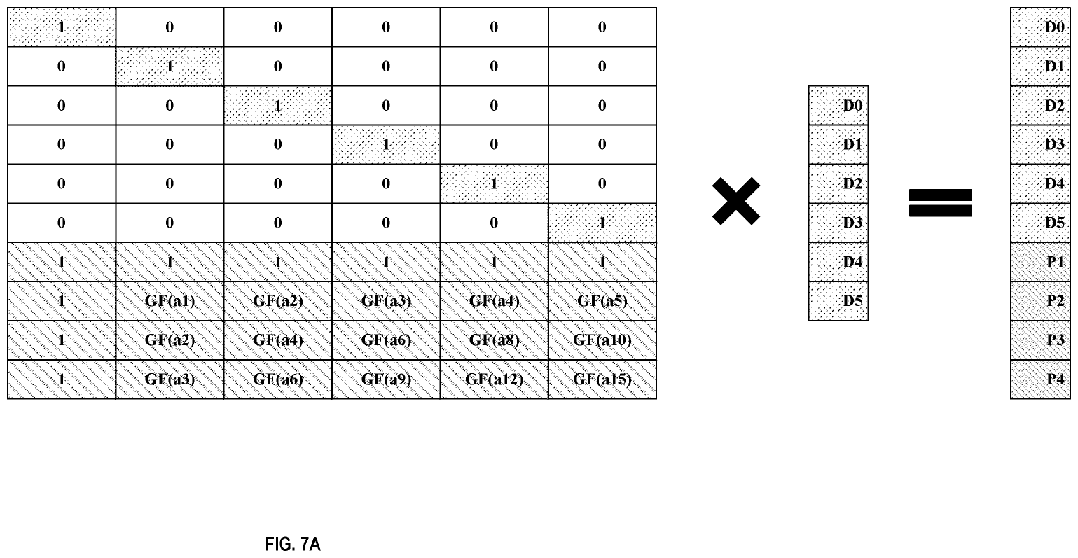

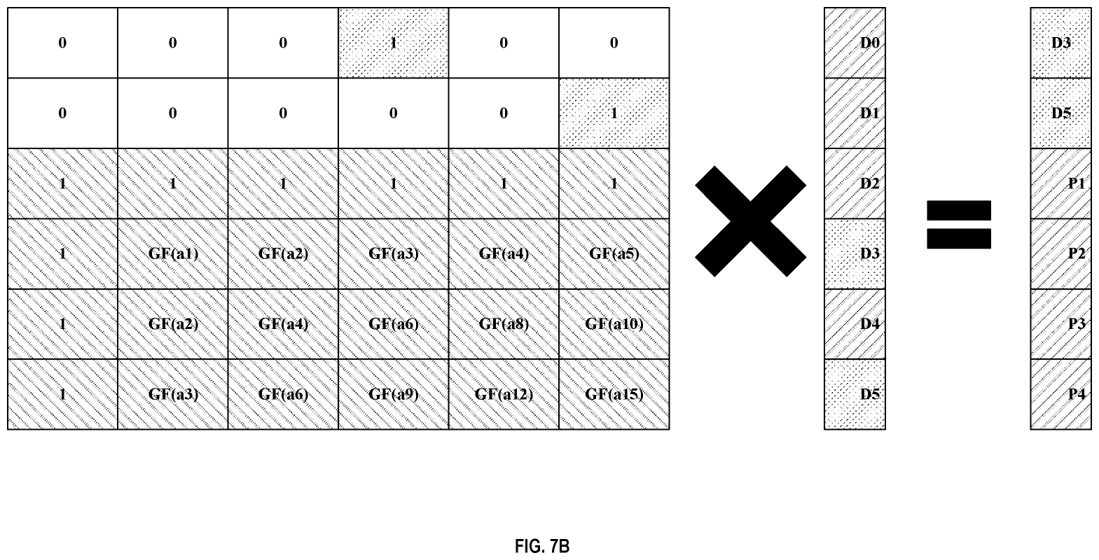

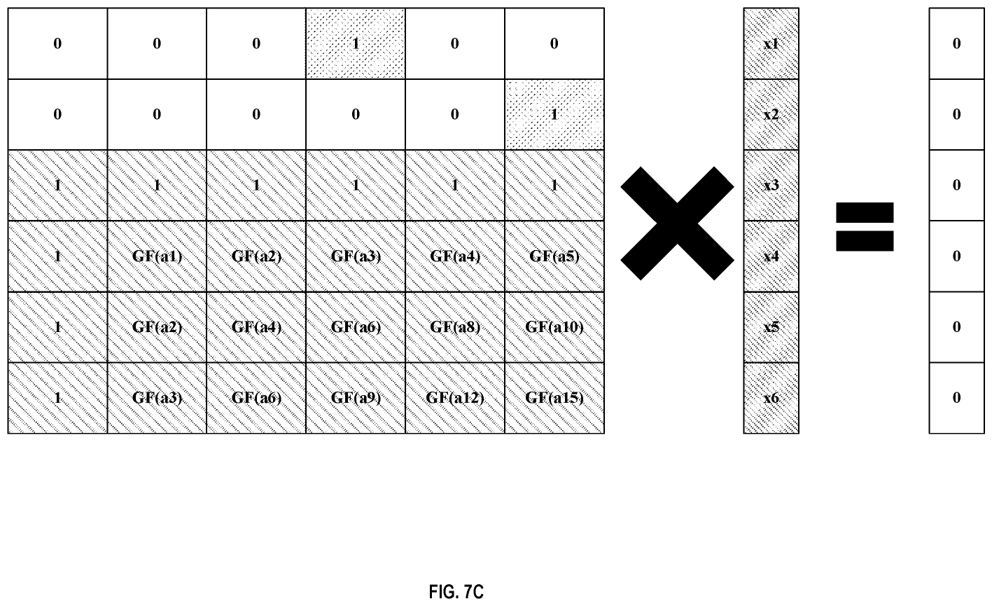

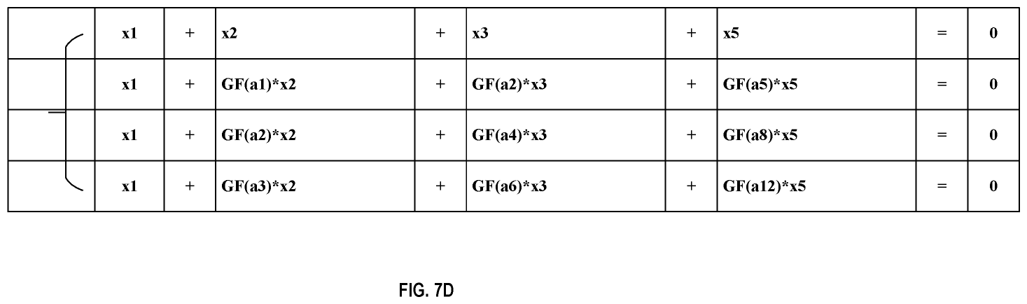

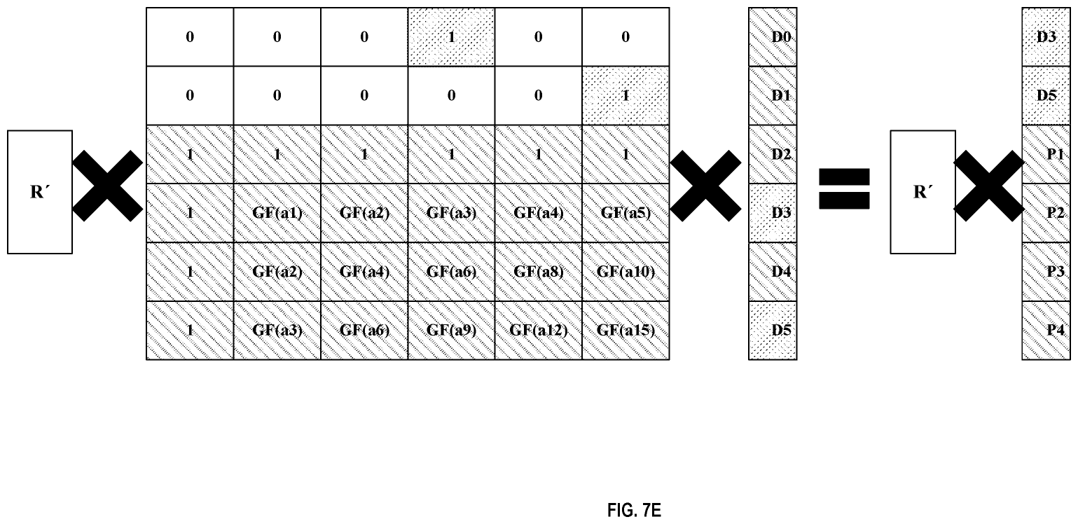

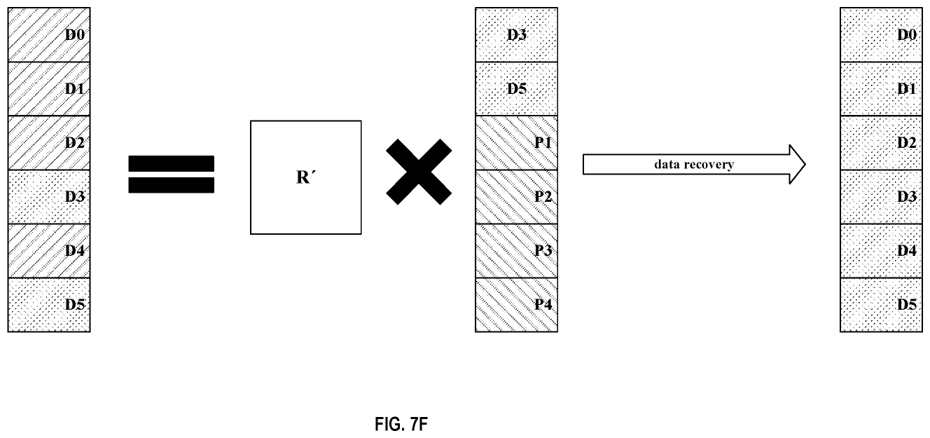

A process of performing data recovery using check data generated by Galois elements with different intervals is illustrated below by taking FIGS. 7A to 7F as an example.

Referring to FIG. 7A, in an example, here, a column vector formed by a group of write data comprises 6 rows, that is, a group of write data comprises data D0, D1, D2, . . . , D5 written to 6 pages. A group of write data generates a group of check data (4 in total, P1 to P4 respectively) through a coefficient matrix (4 rows in total, corresponding to 4 coding equations).

Referring to FIG. 7B, D0, D1, D2 and D4 have errors, and in this case, the coefficient matrix multiplied by the column vector including the error data is a 6×6 square matrix. For ease of understanding, the 6×6 square matrix is called an R square matrix.

Referring to FIG. 7C, the R square matrix is proven to be invertible, that is, there is an invertible matrix R′. According to a identifying method of an invertible matrix, when Rx=0 only has a zero solution, it may be inferred that a rank of the matrix R is 6, then the matrix R is invertible.

Referring to FIG. 7D, by solving an equation set, it can be seen that x1=x2=x3=x4=x5=x6=0, that is, there is only a zero solution, and there is the invertible matrix R′.

Referring to FIG. 7E, two sides of an equation shown in FIG. 7B are multiplied by the invertible matrix R′.

Referring to FIG. 7F, since R×R′=E in which E is a unit matrix, R′ can be calculated according to a method of solving an invertible matrix; at last, raw data is calculated, and the error data in D0, D1, D2 and D4 is corrected at the same time.

In some examples, as shown in FIG. 3, the memory device 300 further comprises: a second memory region 302, wherein the second memory region 302 comprises a plurality of pages, and the plurality of pages included in the second memory region 302 are different from the plurality of pages included in the first memory region. The second memory region 302 is configured to store second check data. The second check data comprises a plurality of groups of check data. Each of the plurality of groups of check data corresponds to one page row in each of the designated word lines, and each group of check data is obtained from the data stored in the corresponding page rows and the same coding equation.

In the examples of the present disclosure, the second memory region 302 is used to store the second check data. Referring to FIG. 3, the data written to all the pages in the memory device 300 is divided into 12 groups. The specific RAID write data grouping manner is described in the above examples, which is not repeated here. Operations are performed for the above 12 groups of write data with the same coding equation respectively (for example, an XOR operation is performed for each group of data), thereby obtaining 12 corresponding groups of check data X0, X1, . . . , X11, that is, the second check data comprises 12 groups of check data. Each group of check data (such as X0) corresponds to one page row (such as a page row corresponding to String0) coupled with each designated word line (such as WL0, WL2, WL4, . . . , WL62), and each group of check data can correct and recover one piece of error data in a corresponding group of write data.

It is to be noted that, for ease of understanding, FIG. 4 exemplarily shows the first memory region storing the first check data, and FIG. 3 exemplarily shows the second memory region storing the second check data. If there is only the first check data in the memory device 300, it may be understood with reference to FIG. 4, that is, the first memory region may be a plurality of pages where WL62 and WL63 are coupled with PL3 of Die1. If there is only the second check data in the memory device 300, it may be understood with reference to FIG. 3, that is, the second memory region may be a plurality of pages where WL62 and WL63 are coupled with PL3 of Die1.

If there are the first check data and the second check data in the memory device 300 simultaneously, then the first memory region and the second memory region may be located at different positions in the memory device 300. For example, the first memory region comprises a plurality of pages where WL62 and WL63 are coupled with PL3 of Die1, and the second memory region comprises a plurality of pages where WL60 and WL61 are coupled with PL3 of Die1. For another example, the first memory region comprises a plurality of pages where WL62 and WL63 are coupled with PL3 of Die1, and the second memory region comprises a plurality of pages where WL62 and WL63 are coupled with PL2 of Die1. It is to be noted that, here, FIGS. 3 and 4 are only examples, and the present disclosure does not limit specific positions of the first memory region and the second memory region in the memory device.

In some examples, although the write data grouping manners shown in FIGS. 3 and 4 are different, the memory devices 300 in FIGS. 3 and 4 are not different in hardware, and storage capacities occupied by the first memory region and the second memory region may also be the same.

In some examples, as shown in FIGS. 3 and 4, all of the memory strings coupled with all of the word lines corresponding to one memory plane form one page column, and the first memory region and the second memory region are both located in one page column.

In the examples of the present disclosure, all of the memory strings coupled with all of the word lines corresponding to one memory plane form one page column. In an example, all of the memory strings String0 to String5 coupled with WL0 to WL63 corresponding to PL0 in Die0 form one page column (i.e., P0, P1, P2, . . . , P383 in the figure). The first memory region and the second memory region may be located in one page column, such that the first check data and the second check data may be both stored in a specific position in the memory device 300 to facilitate management of the memory device.

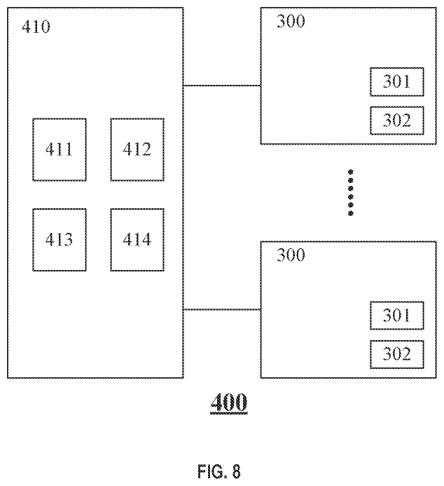

In a second aspect, as shown in FIG. 8, the present disclosure provides a memory system 400. The memory system 400 comprises one or more memory devices 300, and a memory controller 410 coupled with and controlling the memory devices 300, wherein the memory device 300 comprises at least one memory die; each memory die comprises at least one memory plane; each memory plane corresponds to the same plurality of word lines; each word line is coupled with a plurality of memory strings; one memory string coupled with one word line corresponding to one memory plane forms one page; and one memory string coupled with one word line corresponding to all memory planes forms one page row. The memory device 300 comprises a first memory region 301, wherein the first memory region 301 comprises a plurality of pages and stores first check data; the first check data comprises a plurality of groups of check data; each of the plurality of groups of check data corresponds to a plurality of page rows in each of designated word lines; the designated word lines comprise multiple word lines without an interval or with a fixed interval; and each group of check data is obtained from data stored in the corresponding page rows and a plurality of different coding equations. The memory controller 410 is configured to: when a plurality of errors occur upon reading of the data stored in the plurality of page rows in the designated word lines corresponding to one group of check data, perform first error correction for the data with the errors using the first check data.

In the examples of the present disclosure, the memory system 400 may comprise at least one memory device 300, and a memory controller 410 coupled with and controlling the memory device 300. In some examples, the memory system 400 includes, but is not limited to, a solid state drive, such as an enterprise solid state drive (eSSD), and the memory device 300 includes, but is not limited to, a 3D NAND memory. A write data grouping manner of the memory device 300 in this example is described in the above examples, that is, a corresponding group of check data may be generated from each group of write data with a plurality of different coding equations, which is not repeated here. The memory controller 410 may perform the first error correction using a group of check data in the first check data to correct and recover a plurality of pieces of error data in a group of write data.

In an example, the memory controller 410 receives a write command from a host, and receives write data issued by the host to write the write data to the memory device 300. In a process that the memory controller 410 performs a write operation, the memory controller 410 may also perform RAID grouping for the data written to the plurality of pages of the memory device 300, and perform a matrix multiplying operation for each group of write data and an equation coefficient matrix corresponding to one or more coding equations using a coding circuit, so as to obtain a corresponding group of check data. The memory controller 410 may also receive a read command from the host, and read data from the memory device 300. During a process of the read operation, if a group of data written to the memory device 300 has an error, the memory controller 410 may correct and recover one or more pieces of error data using a decoding circuit and through the corresponding group of check data. It may be understood that a number of the pieces of error data of the group of write data that can be corrected by the memory controller 410 is the same as a number of the coding equations (the equation coefficient matrices corresponding to all the coding equations are linearly independent from each other).

In some examples, the first memory region comprises P pages, the first check data comprises Q groups of check data, and each group of check data is obtained from the data stored in the corresponding page rows and P/Q different coding equations, wherein both P and Q are integers greater than 1, and P is a multiple of Q. A group of check data in the first check data can perform error correction for less than or as many as P/Q pieces of error data in the plurality of page rows in the designated word line.

In some examples, as shown in FIG. 8, the memory controller 410 comprises a first coding circuit 411 and a first decoding circuit 412, wherein the first coding circuit 411 is configured to: for the data stored in the page rows corresponding to each of the plurality of groups of check data, perform matrix multiplying operations for the data stored in the page rows corresponding to the corresponding group of check data and equation coefficient matrices corresponding to a plurality of different coding equations, respectively, to obtain the corresponding group of check data; the plurality of groups of check data form the first check data; and the equation coefficient matrices corresponding to respective ones of the plurality of different coding equations are linearly independent from each other. The first decoding circuit 412 is configured to solve an equation set using the first check data and remaining data without an error to obtain correct data corresponding to the error data.

In the examples of the present disclosure, the first coding circuit 411 may be used to perform a matrix multiplying operation for each group of write data and the equation coefficient matrices corresponding to the plurality of different coding equations, so as to obtain a corresponding group of check data. Here, the group of check data may be used to correct a plurality of pieces of error data of the same number as the number of the coding equations. Referring to

FIGS. 7A to 7F, the second decoding circuit 412 may utilize the first check data (P1 to P4) and data (D3 and D5) without an error to solve the equation set, so as to obtain the correct data (D0, D1, D2 and D4) corresponding to the error data.

In some examples, the first coding circuit 411 comprises a linear feedback shift register (LFSR) which is configured to obtain the first check data through a Galois field operation.

In some examples, as shown in FIG. 8, the memory device 300 further comprises: a second memory region 302, wherein the second memory region 302 comprises a plurality of pages, and the plurality of pages included in the second memory region 302 are different from the plurality of pages included in the first memory region. The second memory region 302 stores second check data. The second check data comprises a plurality of groups of check data. Each of the plurality of groups of check data corresponds to one page row in each of the designated word lines, and each group of check data is obtained from the data stored in the corresponding page rows and the same coding equation. The memory controller 410 is configured to: when one error occurs upon reading of the data stored in one page row in the designated word lines corresponding to one group of check data, perform second error correction for the data with the error using the second check data.

In the examples of the present disclosure, referring to FIG. 3, the memory controller may also perform operations for 12 groups of write data with the same coding equation (for example, perform an XOR operation for each group of data) during a write process, so as to obtain 12 corresponding groups of check data X0, X1, . . . , X11, that is, the second check data comprises 12 groups of check data. Each group of check data (such as X0) corresponds to one page row (such as a page row corresponding to String0) coupled with each designated word line (such as WL0, WL2, WL4, . . . , WL62). The memory controller may perform the second error correction using a group of check data in the second check data, to correct and recover one piece of error data in a group of write data.

In some examples, as shown in FIG. 8, the memory controller 410 comprises a second coding circuit 413 and a second decoding circuit 414, wherein the second coding circuit 413 is configured to: for the data stored in the page rows corresponding to each of the plurality of groups of check data, perform matrix multiplying operations for the data stored in the page rows corresponding to the corresponding group of check data and an equation coefficient matrix corresponding to the same coding equation to obtain the corresponding group of check data; and the plurality of groups of check data form the second check data. The second decoding circuit 414 is configured to solve an equation using the second check data and remaining data without an error to obtain correct data corresponding to the error data.

In the examples of the present disclosure, the second coding circuit 413 may be used to perform a matrix multiplying operation for each group of write data and the equation coefficient matrix corresponding to the same coding equation (for example, perform an XOR operation for each group of data), so as to obtain a corresponding group of check data, and the plurality of groups of check data form the second check data. The memory controller 410 may perform the second error correction through the second decoding circuit 414, that is, the second check data and the remaining data without an error are utilized to solve the equation, thereby correcting the error data.

In a third aspect, the present disclosure provides an operation method of a memory system, comprising: when a plurality of errors occur upon reading of data stored in a plurality of page rows in a designated word lines corresponding to one of a plurality of groups of check data, performing first error correction for the data with the errors using first check data, wherein a memory device of the memory system stores the first check data, the first check data comprises the plurality of groups of check data, each of the plurality of groups of check data corresponds to the plurality of page rows in each designated word line, the designated word lines comprise a plurality of word lines without an interval or with a fixed interval, and each group of check data is obtained from the data stored in the corresponding page rows and a plurality of different coding equations.

In some examples, the method further comprises: when an error occurs upon reading of the data stored in one page row in the designated word lines corresponding to a group of check data, performing second error correction for the data with the error using second check data, wherein the memory device stores the second check data. The second check data comprises a plurality of groups of check data. Each of the plurality of groups of check data corresponds to one page row in each of the designated word lines, and each group of check data is obtained from the data stored in the corresponding page rows and the same coding equation.

In the examples of the present disclosure, during a process of performing a write operation, the memory controller may perform two different types of RAID grouping for the data written to the memory device (referring to FIGS. 3 and 4 respectively), so as to generate the first check data and the second check data, and store the first check data and the second check data into the memory device. As such, during a read operation, performing the first error correction using the first check data and/or performing the second error correction using the second check data may be selected according to different error data distributions.

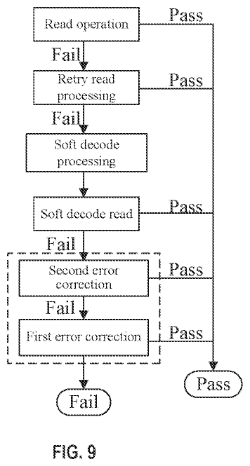

In some examples, as shown in FIG. 9, the method further comprises: performing a read operation for the data stored in the memory device: when an error occurs in the read data, performing retry read processing for the data with the error; when an error still occurs in the data after performing the retry read processing, performing soft decode processing for the data with the error; when an error still occurs in the data after performing the soft decode processing, performing the second error correction for the data with the error using the second check data; and when an error still occurs in the data after performing the second error correction processing, performing the first error correction for the data with the error using the first check data.

In the examples of the present disclosure, in the case where only 1 piece of error data occurs in one page row, the second error correction may be performed, thereby reducing operations produced by the memory controller to recover the data, and improving read operation efficiency. When 2 or more pieces of error data occur in one page row, the first error correction may be performed, thereby improving an error correction capability of the memory system and further improving data reliability of the memory system.

In an example, referring to FIG. 9, when an error occurs in the read data, the retry read processing is first performed; if the retry read fails, the soft decode processing is performed; if the error still occurs in the data after the soft decode processing, the second error correction is performed (1 error in one page row can be corrected); and if the error still occurs in the data after the second error correction, the first error correction is then performed (2 or more errors in one page row can be corrected).

In some examples, the method further comprises: before performing the read operation for the data stored in the memory device, performing a write operation for the memory device, during a process of performing the write operation, storing the first check data corresponding to the current write data into a first memory region of the memory device, and storing the second check data corresponding to the current write data into a second memory region of the memory device.

In the examples of the present disclosure, during the process of performing the write operation, the generated first check data may also be stored in the first memory region, and the generated second check data may be stored in the second memory region respectively. As such, a storage space of the memory device can be arranged reasonably to improve working efficiency of the memory system. It is to be noted that, here, capacities of the first memory region and the second memory region may be not a fixed value, and the memory controller can dynamically adjust the capacity sizes of the first memory region and the second memory region in the memory device, and specific positions of the pages occupied according to a current RAID grouping situation.

The present disclosure provides a memory device, a memory system and an operation method thereof.

In a first aspect, the present disclosure provides a memory device, comprising: at least one memory die, wherein each memory die comprises at least one memory plane; each memory plane corresponds to the same plurality of word lines, each word line being coupled with a plurality of memory strings; one memory string coupled with one word line corresponding to one memory plane forms one page; and one memory string coupled with one word line corresponding to all memory planes forms one page row; and a first memory region comprising a plurality of pages and configured to: store first check data, wherein the first check data comprises a plurality of groups of check data; each of the plurality of groups of check data corresponds to a plurality of page rows in each of designated word lines, the designated word lines comprising multiple word lines without an interval or with a fixed interval; and each group of check data is obtained from data stored in corresponding page rows and a plurality of different coding equations.

In some examples, the first memory region comprises P pages, the first check data comprises Q groups of check data, and each group of check data is obtained from the data stored in the corresponding page rows and P/Q different coding equations, wherein both P and Q are integers greater than 1, and P is a multiple of Q.

In some examples, the first memory region comprises twelve pages; the first check data comprises three groups of check data; each word line is coupled with six memory strings; and the three groups of check data correspond to two adjacent page rows in each word line respectively.

In some examples, each group of check data is obtained by multiplying an equation coefficient matrix corresponding to each of the plurality of different coding equations by a column vector formed by the data stored in all the pages included in the plurality of page rows in the designated word lines corresponding to each group of check data; and the number of columns included in the equation coefficient matrix corresponding to each coding equation is the same as the number of rows included in the column vector.

In some examples, the equation coefficient matrices corresponding to respective ones of the plurality of different coding equations are linearly independent from each other.

In some examples, the plurality of different coding equations include a first coding equation and at least one remaining coding equation; an equation coefficient matrix corresponding to the first coding equation comprises N “1” elements, and an equation coefficient matrix corresponding to each of the at least one remaining coding equation comprisies a “1” and N-1 consecutive non-zero elements; the N-1 consecutive non-zero elements in the equation coefficient matrix corresponding to a different coding equation include Galois elements with a different interval; and wherein N is an integer greater than 1, and N is a total number of the pages corresponding to each group of check data.

In some examples, the memory device further comprises: a second memory region, wherein the second memory region comprises a plurality of pages, and the plurality of pages included in the second memory region are different from the plurality of pages included in the first memory region; and the second memory region is configured to: store a second check data, wherein the second check data comprises a plurality of groups of check data; each of the plurality of groups of check data corresponds to one page row in each of the designated word lines; and each group of check data is obtained from the data stored in the corresponding page rows and the same coding equation.

In some examples, all of the memory strings coupled with all of the word lines corresponding to one memory plane form one page column; and the first memory region and the second memory region are located in one page column.

In a second aspect, the present disclosure provides a memory system. The memory system comprises one or more memory devices, and a memory controller coupled with and controlling the memory devices, wherein the memory device comprises at least one memory die, wherein each memory die comprises at least one memory plane; each memory plane corresponds to the same plurality of word lines, each word line being coupled with a plurality of memory strings; one memory string coupled with one word line corresponding to one memory plane forms one page; one memory string coupled with one word line corresponding to all memory planes forms one page row; the memory device comprises a first memory region, the first memory region comprising a plurality of pages and storing first check data; the first check data comprises a plurality of groups of check data; each of the plurality of groups of check data corresponds to a plurality of page rows in each of designated word lines, the designated word lines comprising multiple word lines without an interval or with a fixed interval; and each group of check data is obtained from data stored in corresponding page rows and a plurality of different coding equations; and the memory controller is configured to: when a plurality of errors occur upon reading of the data stored in the plurality of page rows in the designated word lines corresponding to one group of check data, perform first error correction for the data with the errors using the first check data.

In some examples, the first memory region comprises P pages, the first check data comprises Q groups of check data, and each group of check data is obtained from the data stored in the corresponding page rows and P/Q different coding equations, wherein both P and Q are integers greater than 1, and P is a multiple of Q; and a group of check data in the first check data can perform error correction for less than or as many as P/Q pieces of error data in the plurality of page rows in the designated word lines.

In some examples, the memory controller comprises: a first coding circuit configured to: for the data stored in the page rows corresponding to each of the plurality of groups of check data, perform matrix multiplying operations for the data stored in the page rows corresponding to the corresponding group of check data and equation coefficient matrices corresponding to the plurality of different coding equations, respectively, to obtain the corresponding group of check data, wherein the plurality of groups of check data form the first check data, and the equation coefficient matrices corresponding to respective ones of the plurality of different coding equations are linearly independent from each other; and a first decoding circuit configured to solve an equation set using the first check data and remaining data without an error to obtain correct data corresponding to the error data.

In some examples, the first coding circuit comprises a linear feedback shift register which is configured to obtain the first check data through a Galois field operation.

In some examples, the memory device further comprises a second memory region; the second memory region comprises a plurality of pages, the plurality of pages included in the second memory region being different from the plurality of pages included in the first memory region; the second memory region stores second check data; the second check data comprises a plurality of groups of check data; each of the plurality of groups of check data corresponds to one page row in each of the designated word lines; each group of check data is obtained from data stored in the corresponding page rows and the same coding equation; and the memory controller is configured to: when one error occurs upon reading of the data stored in one page row in the designated word lines corresponding to one group of check data, perform second error correction for the data with the error using the second check data.

In some examples, the memory controller comprises: a second coding circuit configured to: for the data stored in the page rows corresponding to each of the plurality of groups of check data, perform a matrix multiplying operation for the data stored in the page rows corresponding to the corresponding group of check data and an equation coefficient matrix corresponding to the same coding equation, to obtain the corresponding group of check data, wherein the plurality of groups of check data form the second check data; and a second decoding circuit configured to solve an equation using the second check data and remaining data without an error to obtain correct data corresponding to the error data.

In a third aspect, the present disclosure provides an operation method of a memory system, comprising: when a plurality of errors occur upon reading of data stored in a plurality of page rows in designated word lines corresponding to one of a plurality of groups of check data, performing first error correction for the data with the errors using first check data, wherein a memory device of the memory system stores the first check data; the first check data comprises the plurality of groups of check data; each of the plurality of groups of check data corresponds to a plurality of page rows in each of designated word lines, the designated word lines comprising multiple word lines without an interval or with a fixed interval; and each group of check data is obtained from the data stored in corresponding page rows and a plurality of different coding equations.

In some examples, the method further comprises: when one error occurs upon reading of the data stored in one page row in the designated word lines corresponding to one group of check data, performing second error correction for the data with the error using second check data, wherein the memory device stores the second check data; the second check data comprises a plurality of groups of check data; each of the plurality of groups of check data corresponds to one page row in each of the designated word lines; and each group of check data is obtained from the data stored in the corresponding page rows and the same coding equation.

In some examples, the method further comprises: performing a read operation for data stored in the memory device; when an error occurs in the read data, performing retry read processing for the data with the error; when an error still occurs in the data after performing the retry read processing, performing soft decode processing for the data with the error; when an error still occurs in the data after performing the soft decode processing, performing second error correction for the data with the error using the second check data; and when an error still occurs in the data after performing the second error correction, performing first error correction for the data with the error using the first check data.

In some examples, the method further comprises: before performing the read operation for the data stored in the memory device, performing a write operation for the memory device; and during the process of performing the write operation, storing the first check data corresponding to the current write data into a first memory region of the memory device, and storing the second check data corresponding to the current write data into a second memory region of the memory device.

In the memory device provided by the examples of the present disclosure, the first check data comprises a plurality of groups of check data, wherein each group of check data corresponds to the plurality of page rows in the designated word lines, and each group of check data is obtained from the data stored in the corresponding page rows and the plurality of different coding equations. As such, on the one hand, a corresponding group of check data may be generated from the data stored in the plurality of page rows in the designated word lines through the plurality of different coding equations, such that a storage capacity occupied by the first check data is small; on the other hand, a group of check data may correct a plurality of errors of the same number as the number of the plurality of coding equations, thus improving an error correction capability of the memory and further improving data reliability of the memory.

It is to be understood that, references to “one example” or “an example” throughout this specification mean that particular features, structures, or characteristics related to the example are included in at least one example of the present disclosure. Therefore, “in one example” or “in an example” presented everywhere throughout this specification does not necessarily refer to the same example. Furthermore, these particular features, structures, or characteristics may be incorporated in one or more examples in any suitable manner. It is to be understood that, in various examples of the present disclosure, sequence numbers of the above processes do not indicate an execution sequence, and an execution sequence of various processes shall be determined by functionalities and intrinsic logics thereof, and shall constitute no limitation on an implementation process of the examples of the present disclosure. The above sequence numbers of the examples of the present disclosure are only for description, and do not represent advantages and disadvantages of the examples.

The above descriptions are merely preferred examples of the present disclosure, and not intended to limit the patent scope of the present disclosure. Equivalent structure transformation made using the contents of the specification and the drawings of the present disclosure under the inventive concept of the present disclosure, or direct/indirect application to other related technical fields are encompassed within the patent protection scope of the present disclosure.

What is claimed is:

1. A memory device, comprising:
a memory die, wherein
the memory die comprises a memory plane;
the memory plane corresponds to the same plurality of word lines, each word line being coupled with a plurality of memory strings;
one memory string coupled with one word line corresponding to one memory plane forms one page; and
one memory string coupled with one word line corresponding to all memory planes forms one page row; and
a first memory region comprising a plurality of pages and configured to:
store first check data, wherein
the first check data comprises a plurality of groups of check data;
each of the plurality of groups of check data corresponds to a plurality of page rows in each of designated word lines, the designated word lines comprising multiple word lines without an interval or with a fixed interval; and
each group of check data is obtained from data stored in corresponding page rows and a plurality of different coding equations.

2. The memory device of claim 1, wherein
the first memory region comprises P pages, the first check data comprises Q groups of check data, and each group of check data is obtained from the data stored in the corresponding page rows and P/Q different coding equations, wherein both P and Q are integers greater than 1, and P is a multiple of Q.

3. The memory device of claim 2, wherein
the first memory region comprises twelve pages;
the first check data comprises three groups of check data;
each word line is coupled with six memory strings; and
the three groups of check data correspond to two adjacent page rows in each word line respectively.

4. The memory device of claim 1, wherein
each group of check data is obtained by multiplying an equation coefficient matrix corresponding to each of the plurality of different coding equations by a column vector formed by the data stored in all the pages included in the plurality of page rows in the designated word lines corresponding to each group of check data; and
a number of columns included in the equation coefficient matrix corresponding to each coding equation is the same as the number of rows included in the column vector.

5. The memory device of claim 1, wherein equation coefficient matrices corresponding to respective ones of the plurality of different coding equations are linearly independent from each other.

6. The memory device of claim 5, wherein
the plurality of different coding equations include a first coding equation and a remaining coding equation;
an equation coefficient matrix corresponding to the first coding equation comprises N “1” elements, and an equation coefficient matrix corresponding to each of the remaining coding equation comprisies a “1” and N-1 consecutive non-zero elements;
the N-1 consecutive non-zero elements in the equation coefficient matrix corresponding to a different coding equation include Galois elements with a different interval; and
wherein N is an integer greater than 1, and N is a total number of the pages corresponding to each group of check data.

7. The memory device of claim 1, wherein
the memory device further comprises: a second memory region, wherein the second memory region comprises a plurality of pages, and the plurality of pages included in the second memory region are different from the plurality of pages included in the first memory region; and
the second memory region is configured to:
store a second check data, wherein the second check data comprises a plurality of groups of check data; each of the plurality of groups of check data corresponds to one page row in each of the designated word lines; and each group of check data is obtained from the data stored in the corresponding page rows and the same coding equation.

8. The memory device of claim 7, wherein
all of the memory strings coupled with all of the word lines corresponding to one memory plane form one page column; and
the first memory region and the second memory region are located in one page column.

9. A memory system, comprising:
one or more memory devices, and
a memory controller coupled with and controlling the memory devices, wherein
the memory device comprises a memory die, wherein
the memory die comprises a memory plane;
the memory plane corresponds to the same plurality of word lines, each word line being coupled with a plurality of memory strings;
one memory string coupled with one word line corresponding to one memory plane forms one page;
one memory string coupled with one word line corresponding to all memory planes forms one page row;
the memory device comprises a first memory region, the first memory region comprising a plurality of pages and storing first check data;
the first check data comprises a plurality of groups of check data;
each of the plurality of groups of check data corresponds to a plurality of page rows in each of designated word lines, the designated word lines comprising multiple word lines without an interval or with a fixed interval; and
each group of check data is obtained from data stored in corresponding page rows and a plurality of different coding equations; and
the memory controller is configured to:
when a plurality of errors occur upon reading of the data stored in the plurality of page rows in the designated word lines corresponding to one group of check data, perform first error correction for the data with the errors using the first check data.

10. The memory system of claim 9, wherein
the first memory region comprises P pages, the first check data comprises Q groups of check data, and each group of check data is obtained from the data stored in the corresponding page rows and P/Q different coding equations, wherein both P and Q are integers greater than 1, and P is a multiple of Q; and
a group of check data in the first check data can perform error correction for less than or as many as P/Q pieces of error data in the plurality of page rows in the designated word lines.

11. The memory system of claim 9, wherein the memory controller comprises:
a first coding circuit configured to: for the data stored in the page rows corresponding to each of the plurality of groups of check data, perform matrix multiplying operations for the data stored in the page rows corresponding to the corresponding group of check data and equation coefficient matrices corresponding to the plurality of different coding equations, respectively, to obtain the corresponding group of check data, wherein the plurality of groups of check data form the first check data, and the equation coefficient matrices corresponding to respective ones of the plurality of different coding equations are linearly independent from each other; and
a first decoding circuit configured to solve an equation set using the first check data and remaining data without an error to obtain correct data corresponding to the error data.

12. The memory system of claim 11, wherein the first coding circuit comprises a linear feedback shift register which is configured to obtain the first check data through a Galois field operation.

13. The memory system of claim 9, wherein
the memory device further comprises a second memory region;
the second memory region comprises a plurality of pages, the plurality of pages included in the second memory region being different from the plurality of pages included in the first memory region;
the second memory region stores second check data;
the second check data comprises a plurality of groups of check data;
each of the plurality of groups of check data corresponds to one page row in each of the designated word lines;
each group of check data is obtained from data stored in the corresponding page rows and the same coding equation; and
the memory controller is configured to:
when one error occurs upon reading of the data stored in one page row in the designated word lines corresponding to one group of check data, perform second error correction for the data with the error using the second check data.

14. The memory system of claim 13, wherein the memory controller comprises:
a second coding circuit configured to: for the data stored in the page rows corresponding to each of the plurality of groups of check data, perform a matrix multiplying operation for the data stored in the page rows corresponding to the corresponding group of check data and an equation coefficient matrix corresponding to the same coding equation, to obtain the corresponding group of check data, wherein the plurality of groups of check data form the second check data; and
a second decoding circuit configured to solve an equation using the second check data and remaining data without an error to obtain correct data corresponding to the error data.

15. An operation method of a memory system, comprising:
when a plurality of errors occur upon reading of data stored in a plurality of page rows in designated word lines corresponding to one of a plurality of groups of check data, performing first error correction for the data with the errors using first check data; and
when an error occurs upon reading of the data stored in one page row in the designated word lines corresponding to one group of check data, performing second error correction for the data with the error using second check data,
wherein
a memory device of the memory system stores the first check data and the second check data;
the first check data and the second check data comprise the plurality of groups of check data;
each of the plurality of groups of check data corresponds to a plurality of page rows in each of designated word lines, the designated word lines comprising multiple word lines without an interval or with a fixed interval; and
each group of check data is obtained from the data stored in corresponding page rows and a plurality of different coding equations.

16. The operation method of the memory system of claim 15, further comprising:
performing a read operation for data stored in the memory device;
when an error occurs in the read data, performing retry read processing for the data with the error;
when an error still occurs in the data after performing the retry read processing, performing soft decode processing for the data with the error;
when an error still occurs in the data after performing the soft decode processing, performing second error correction for the data with the error using the second check data; and
when an error still occurs in the data after performing the second error correction, performing first error correction for the data with the error using the first check data.

17. The operation method of the memory system of claim 16, further comprising:
before performing the read operation for the data stored in the memory device, performing a write operation for the memory device; and
during the process of performing the write operation, storing the first check data corresponding to a current write data into a first memory region of the memory device, and storing the second check data corresponding to the current write data into a second memory region of the memory device.
